(19) United States
(12) Patent Application Publication
(10) Pub. No.: US 2020/0285055 A1
(43) Pub. Date: Sep. 10, 2020

(54) DIRECT RETINA PROJECTION APPARATUS AND METHOD

(71) Applicant: Varjo Technologies Oy

(72) Inventor: Evgeny Shirko, Saint-Petersburg (RU)

(21) Appl. No.: 16/296,639

(22) Filed: Mar. 8, 2019

(51) Int. Cl. G02B 27/01; G02B 27/22; G06T 19/00; G06F 3/01

(52) U.S. Cl. CPC G02B 27/0172; G02B 27/2292; G02B 2027/014; G06F 3/013; G02B 27/0179; G06T 19/006

(57) ABSTRACT

A direct retina projection apparatus includes means for detecting a gaze direction of a user, a projector, an optical element, a reflective element, an actuator and a processor. The processor is configured to determine, based upon the gaze direction of the user, a portion of the optical element at or through which the user is gazing. The processor is configured to render an image via the projector, whilst adjusting an orientation of the reflective element, via the actuator, to reflect a projection of the image from the reflective element towards the optical element according to the detected gaze direction. A projection of at least a portion of the rendered image is to be reflected from the reflective element towards the portion of the optical element from where the projection of the at least a portion of the rendered image is directed towards a fovea of the user's eye.

### TECHNICAL FIELD

The present disclosure relates to direct retina projection apparatus. Moreover, the present disclosure also relates to methods of displaying, via the aforementioned direct retina projection apparatus.

### BACKGROUND

In recent times, several technologies (for example, such as virtual reality (VR), augmented reality (AR), mixed reality (MR) and extended reality (XR)) are being used to present interactive simulated environments to users. The users utilize specialized Head-Mounted Devices (HMDs) for experiencing and interacting with such simulated environments.

However, conventional specialized HMDs have certain limitations associated therewith. Firstly, the conventional HMDs provide a narrow field of view, due to limitations of existing displays implemented therein. Some of the conventional HMDs have employed waveguides to increase the field of view to some extent, but at the cost of lowering a perceived resolution. Secondly, the conventional HMDs also fail to provide a high-resolution display, which prevents the user from immersing into a simulated environment presented therein. Thirdly, if at all a high-resolution display is provided, it has been achieved by implementing larger displays to increase the resolution in an entire visual scene. This, in turn, makes these HMDs bulkier. Fourthly, in conventional direct retinal projection device, the user is required to keep her/his head and eye within a certain position range. Wearing such a device even slightly incorrectly leads to a loss of view. This restricts her/his freedom of usage significantly.

Therefore, in light of the foregoing discussion, there exists a need to overcome the aforementioned drawbacks associated with conventional HMDs.

### SUMMARY

The present disclosure seeks to provide a direct retina projection apparatus. The present disclosure also seeks to provide a method of displaying, via a direct retina projection apparatus. The present disclosure seeks to provide at least a portion of a visual scene whereat a user's gaze is directed with a high resolution, whilst also providing for a wide field of view. Moreover, the present disclosure also seeks to provide a solution to the existing problems of pixel density and physical size trade-offs in devices implementing simulated environments.

In one aspect, an embodiment of the present disclosure provides a direct retina projection apparatus comprising:

means for detecting a gaze direction of a user;

at least one projector, wherein the at least one projector is to be employed to render an image;

at least one optical element arranged to receive and direct a projection of the rendered image towards a retina of a user's eye when the projection apparatus in operation is worn by the user;

at least one reflective element arranged on an optical path between the at least one projector and the at least one optical element;

at least one first actuator for adjusting an orientation of the at least one reflective element; and

at least one processor configured to:

determine, based upon the detected gaze direction of the user, a given portion of the at least one optical element at or through which the user is gazing; and

control the at least one first actuator to reflect the projection of the rendered image from the at least one reflective element towards the at least one optical element according to the detected gaze direction of the user, wherein a projection of at least a portion of the rendered image is to be reflected from the at least one reflective element towards the given portion of the at least one optical element from where the projection of the at least a portion of the rendered image is directed towards a fovea of the user's eye.

In another aspect, an embodiment of the present disclosure provides a method of displaying, via a direct retina projection apparatus comprising at least one projector, at least one optical element and at least one reflective element arranged between the at least one projector and the at least one optical element, the method comprising:

detecting a gaze direction of a user;

determining, based upon the detected gaze direction of the user, a given portion of the at least one optical element at or through which the user is gazing;

rendering an image via the at least one projector; and

adjusting an orientation of the at least one reflective element to reflect the projection of the rendered image from the at least one reflective element towards the at least one optical element according to the detected gaze direction of the user, wherein a projection of at least a portion of the rendered image is reflected from the at least one reflective element towards the given portion of the at least one optical element from where the projection of the at least a portion of the rendered image is directed towards a fovea of the user's eye.

Embodiments of the present disclosure substantially eliminate or at least partially address the aforementioned problems in the prior art, and enable a projection apparatus for implementing simulated environments to mimic the human visual system.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of architecture of a direct retina projection apparatus, in accordance with an embodiment of the present disclosure;

FIG. 2 is a block diagram of architecture of a direct retina projection apparatus, in accordance with a specific embodiment of the present disclosure;

FIGS. 3A and 3B are schematic illustrations of how active foveation is achieved in a direct retina projection apparatus, in accordance with an embodiment of the present disclosure;

FIGS. 4 and 5 are schematic illustrations of exemplary implementations of a direct retina projection apparatus, in accordance with different embodiments of the present disclosure;

FIG. 6 is a schematic illustration of how an image is formed when a planar reflective element is employed, in accordance with an embodiment of the present disclosure;

FIG. 7 is a schematic illustration of how an image is formed when a convex eflective element is employed, in accordance with another embodiment of the present disclosure;

FIG. 8 is an exemplary implementation of means for detecting a gaze direction of a user in a direct retina projection apparatus, in accordance with an embodiment of the present disclosure;

FIGS. 9A and 9B are exemplary implementations of at least one optical element in a direct retina projection apparatus, in accordance with an embodiment of the present disclosure;

FIG. 10 is another exemplary implementation of at least one optical element in a direct retina projection apparatus, in accordance with another embodiment of the present disclosure;

FIGS. 11 and 12 are schematic illustrations of example implementations of a direct retina projection apparatus in which a single projector is employed on a shared basis, according to different embodiments of the present disclosure;

FIGS. 13A, 13B and 13C are exemplary implementations of at least one first actuator associated with at least one reflective element in a direct retina projection apparatus, in accordance with various embodiments of the present disclosure;

FIGS. 14A and 14B are schematic illustrations of how an image is rendered in a direct retina projection apparatus, in accordance with different embodiments of the present disclosure;

FIGS. 15A and 15B are schematic illustrations of how an input image is processed to generate an image to be rendered, in accordance with an embodiment of the present disclosure; and

FIG. 16 is an illustration of steps of a method of displaying, via a direct retina projection apparatus, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a direct retina projection apparatus comprising:

means for detecting a gaze direction of a user;

at least one projector, wherein the at least one projector is to be employed to render an image;

at least one optical element arranged to receive and direct a projection of the rendered image towards a retina of a user's eye when the projection apparatus in operation is worn by the user;

at least one reflective element arranged on an optical path between the at least one projector and the at least one optical element;

at least one first actuator for adjusting an orientation of the at least one reflective element; and

at least one processor configured to:

determine, based upon the detected gaze direction of the user, a given portion of the at least one optical element at or through which the user is gazing; and

control the at least one first actuator to reflect the projection of the rendered image from the at least one reflective element towards the at least one optical element according to the detected gaze direction of the user, wherein a projection of at least a portion of the rendered image is to be reflected from the at least one reflective element towards the given portion of the at least one optical element from where the projection of the at least a portion of the rendered image is directed towards a fovea of the user's eye.

In another aspect, an embodiment of the present disclosure provides a method of displaying, via a direct retina projection apparatus comprising at least one projector, at least one optical element and at least one reflective element arranged between the at least one projector and the at least one optical element, the method comprising:

detecting a gaze direction of a user;

determining, based upon the detected gaze direction of the user, a given portion of the at least one optical element at or through which the user is gazing;

rendering an image via the at least one projector; and

adjusting an orientation of the at least one reflective element to reflect the projection of the rendered image from the at least one reflective element towards the at least one optical element according to the detected gaze direction of the user, wherein a projection of at least a portion of the rendered image is reflected from the at least one reflective element towards the given portion of the at least one optical element from where the projection of the at least a portion of the rendered image is directed towards a fovea of the user's eye.

Pursuant to embodiments of the present disclosure, the orientation of the at least one reflective element is adjusted according to the detected gaze direction of the user, thereby following the user's gaze as and when it changes. As a result, at least a portion of each rendered image is directed towards the fovea of the user's eye, even when the user's gaze keeps shifting. This enables the projection apparatus to simulate active foveation of the human visual system in an efficient manner. In the projection apparatus, optical properties and/or an optical path of a light beam are adjusted by way of sophisticated equipment for emulating foveation characteristics of the human visual system accurately.

Moreover, the aforesaid projection apparatus is compact and lightweight. Beneficially, the aforesaid method is implemented in real-time or near-real time. Notably, the projection apparatus has a negligible processing lag, and provides the user with a rich immersive experience of a simulated environment.

Furthermore, the projection apparatus is suitable for directing a narrow foveated projection of the rendered image towards the retina of the user's eye, thereby providing the user with a high-resolution visual scene even with a low-resolution projector.

Throughout the present disclosure, the term “projection apparatus” refers to specialized equipment that is configured to present a visual scene of a simulated environment to a user when the projection apparatus in operation is worn by the user on her/his head. Examples of the simulated environment can include a fully virtual environment (namely, a Virtual Reality (VR) environment) as well as a real-world environment including simulated objects therein (namely, an Augmented Reality (AR) environment, a Mixed Reality (MR) environment and the like). Therefore, the projection apparatus acts as a device (for example, such as a VR headset, an AR headset, an MR headset, a pair of VR glasses, a pair of AR glasses, a pair of MR glasses and so forth) that, when operated, presents the visual scene of the simulated environment to the user.

The term “visual scene” refers to a sequence of images that are to be presented to the user, via the projection apparatus. As an example, the visual scene may be a virtual reality movie. As another example, the visual scene may be an educational augmented reality video. As yet another example, the visual scene may be a mixed reality game.

Throughout the present disclosure, the term “means for detecting gaze direction” refers to specialized equipment for detecting a direction of gaze of the user's eye and tracking a movement of the user's eye. It will be appreciated that said means may or may not be placed in contact with the user's eye.

Optionally, said means comprises a configuration of gaze sensors. Such a configuration of gaze sensors may, for example, be implemented as sensors within contact lenses, cameras monitoring a position of a pupil of the user's eye, and an eye-surface-scanning laser and its associated camera. In such a case, the at least one processor is configured to process sensor data collected by the configuration of gaze sensors to determine a current gaze location and a current gaze velocity and/or acceleration of the user.

Optionally, the at least one processor is configured to predict a gaze location and a gaze velocity and/or acceleration of the user, based at least partially upon the current gaze location and the current gaze velocity and/or acceleration.

Additionally, optionally, the at least one processor is configured to predict the gaze location and the gaze velocity and/or acceleration of the user, based also upon scene information pertaining to the sequence of images being rendered. Optionally, in this regard, the scene information comprises information indicative of a location of an object present in the visual scene that has at least one of: an audio feature of interest, a visual feature of interest, a physical interaction with another object present in the visual scene. Notably, if the object has audio features of interest, visual features of interest, physical interactions with other objects, and so forth, there exists a high likelihood that the user's gaze would be directed towards such an object, as such characteristics generally attract the user's attention.

Moreover, optionally, the at least one processor is configured to determine, based upon the predicted gaze location and the predicted gaze velocity and/or acceleration, a next region of the at least one optical element at or through which the user is likely to gaze, and to control the at least one first actuator accordingly.

Furthermore, optionally, the projection apparatus comprises at least one second actuator for adjusting an orientation of the at least one projector with respect to the at least one reflective element, wherein the at least one processor is configured to control the at least one second actuator along with the at least one first actuator to adjust a location of the projection of the at least a portion of the rendered image on the at least one optical element according to the detected gaze direction of the user.

Optionally, the at least one first actuator and/or the at least one second actuator are tiltable, rotatable and/or translatable in one or more dimensions.

More optionally, the at least one second actuator is tiltable along at least one axis, and the at least one first actuator is tiltable along at least one orthogonal axis. Herein, the at least one orthogonal axis is orthogonal to the at least one axis.

Throughout the present disclosure, the term “actuator” refers to an equipment that is employed to rotate, tilt and/or translate a component with which it is associated. Such equipment may, for example, include electrical components, mechanical components, magnetic components, polymeric components and so forth. Such an actuator is driven by an actuation signal. It will be appreciated that the actuation signal could be a piezoelectric force, an electromagnetic force, a mechanical torque, an electric current, a hydraulic pressure, a pneumatic pressure or similar. As an example, the actuator may comprise a motor, an axle and a plurality of bearings (for example, three or more bearings). As another example, the actuator may comprise a voice coil. As yet another example, the actuator may comprise piezo-electronic components.

Moreover, optionally, the at least one projector comprises at least one light source that in operation emits a light beam, and at least one beam scanning arrangement that in operation directs the light beam towards the at least one reflective element and sweeps the light beam according to a scanning pattern.

Optionally, the light beam is substantially collimated. Optionally, in such a case, the at least one light source comprises at least one collimating element (for example, such as a collimating lens) that is arranged to adjust a cross section of the light beam.

Optionally, the light beam is substantially monochromatic. Optionally, in this regard, the at least one light source comprises an optical filter that is arranged to allow light of only a given wavelength or a given wavelength range to pass therethrough and be consequently emitted from the at least one light source.

Examples of the at least one light source include, but are not limited to, a laser diode, a solid-state laser, a light emitting diode and a cathode ray tube.

Throughout the present disclosure, the term “beam scanning arrangement” refers to an equipment that can be controlled to direct the light beam towards the at least one reflective element, and to sweep the light beam over the at least one reflective element in order to draw the aforesaid image.

Optionally, the at least one beam scanning arrangement comprises a controllable scanning mirror that is arranged to reflect the light beam towards the at least one reflective element; and at least one third actuator associated with the controllable scanning mirror. The at least one third actuator is adjustable in at least one dimension. Optionally, in this regard, the at least one third actuator is tiltable, rotatable and/or translatable in one or more dimensions.

Optionally, the at least one beam scanning arrangement in operation draws different regions of the aforesaid image at varying frequencies.

Optionally, the scanning pattern is a raster scanning pattern. In a given raster scanning pattern, the light beam is swept both horizontally and vertically across a surface of the at least one reflective element in a line-by-line manner, wherein a horizontal sweep is employed to draw a row of pixels in a given region, while a vertical sweep is employed to jump onto a next row of pixels in the given region.

Alternatively, optionally, the scanning pattern is a Lissajous scanning pattern. In a given Lissajous scanning pattern, the light beam is swept both horizontally and vertically across the surface of the at least one reflective element in a non-linear trajectory that is based on a Lissajous curve.

It will be appreciated that raster and lissajous scanning patterns are well known in the art.

Yet alternatively, optionally, the scanning pattern is a spiral scanning pattern. Hereinabove, the term “spiral” refers to a curve beginning from a point and extending around the point in a substantially-circular manner. A spiral may, for example, be implemented as an Archimedean spiral, a logarithmic spiral, or a plurality of concentric circles.

In case of concentric circles, the light beam is to be swept along a circumference of a given circle before moving onto another circle adjacent to the given circle. In such a case, a common center of the plurality of concentric circles can be considered as a center of the spiral.

Optionally, a distance between the plurality of concentric circles is equal. Alternatively, optionally, a distance between the plurality of concentric circles is unequal. More optionally, a distance between adjacent circles increases with an increase in radii of the adjacent circles.

It will be appreciated that while drawing the aforesaid image, the light beam need not necessarily fill an entire region of the at least one reflective element. In other words, when the light beam is swept to draw the aforesaid image, there may exist some gaps (or un-scanned portions) in certain regions of the at least one reflective element. However, it will be appreciated that the light beam is swept in a manner that the gaps (if any) are imperceptible to the user. Optionally, the distance between successive turnings of the spiral and a number of turnings of the spiral are adjustable.

Optionally, the at least one projector further comprises at least one beam modulation arrangement that, in operation, modulates at least one of: an intensity of the light beam, a wavelength of the light beam, a width of the light beam. The beam modulation arrangement can modulate the light beam directly (for example, by controlling a drive signal of the at least one light source) and/or indirectly (for example, via optical modulation devices arranged on an optical path of the light beam). In some implementations, the at least one beam modulation arrangement is coupled to the at least one processor. In other implementations, the at least one beam modulation arrangement is implemented by way of the at least one processor.

Optionally, the intensity and/or the width of the light beam are to be modulated according to a variation in a resolution of the aforesaid image. Optionally, the resolution of the image varies inversely as a function of an angular distance from a center of the image. Such a variation in the resolution of the image on going from the center towards an edge of the image can be linear, non-linear (for example, such as exponential), step-wise (namely, as discrete values), or a combination thereof. Notably, such a variation in the resolution of the image is substantially similar to a resolution curve of the human visual system, which represents an inverse variation in the resolution of a human's eye with respect to an angular distance from a fovea of the human's eye.

As an example, in case of a spiral scanning pattern, the resolution of the image varies inversely as a function of an angular distance from the center of the spiral.

Optionally, an angular pixel size in a peripheral portion of the image would be greater than an angular pixel size in a central portion of the image. Optionally, in this regard, the width of the light beam is to be modulated in a manner that the width of the light beam required for sweeping the peripheral portion of the image is greater than the width of the light beam required for sweeping the central portion of the image.

Optionally, the intensity of the light beam is to be modulated in a manner that the intensity of the light beam increases with an increase in the angular pixel size, and vice versa.

Optionally, the wavelength of the light beam is to be modulated according to color information of the aforesaid image.

Optionally, the at least one light source and the at least one beam modulation arrangement are implemented as an integrated unit. Alternatively, optionally, the at least one light source and the at least one beam modulation arrangement are implemented as separate units within the at least one projector.

Moreover, in some implementations, the at least one projector comprises separate projectors for left and right eyes of the user.

In other implementations, the at least one projector is used for both the left and right eyes of the user on a shared basis. This potentially reduces the cost of the aforesaid projection apparatus, whilst making the projection apparatus more compact and more energy efficient, as compared to a case where the projection apparatus has separate projectors for the left and right eyes of the user.

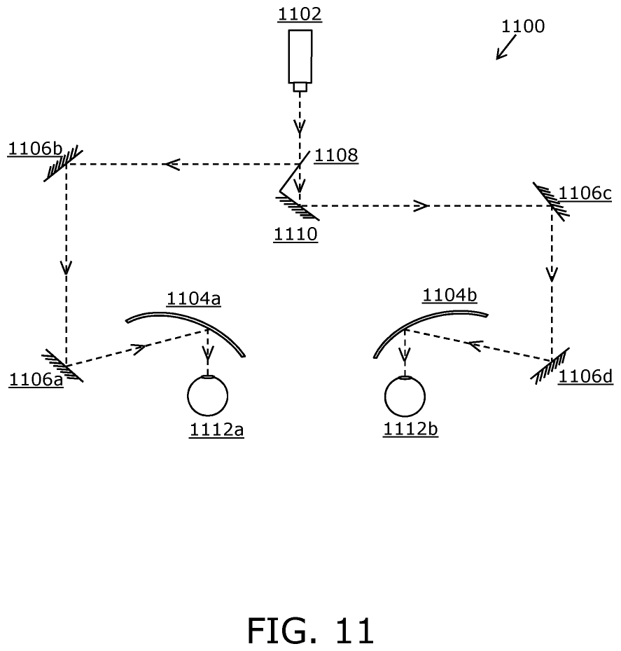

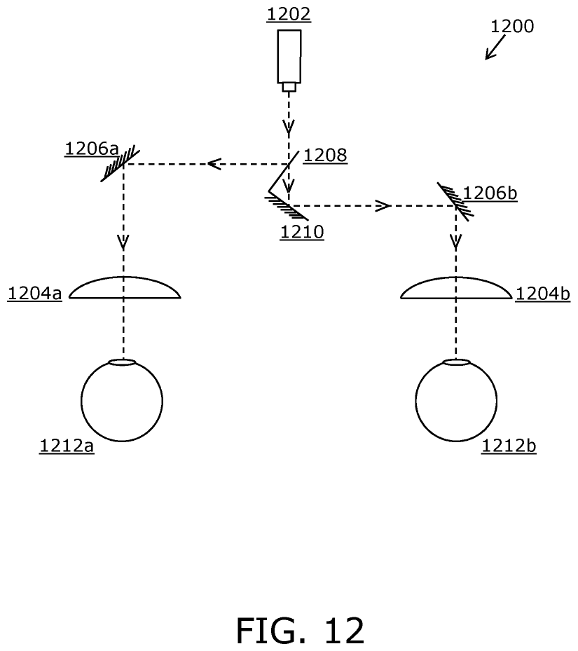

Two such example implementations have been illustrated in conjunction with FIGS. 11 and 12 as explained in detail below. Optionally, in such an implementation, the projection apparatus further comprises a configuration of a semi-transparent reflective element and an additional reflective element arranged on an optical path between the at least one projector and the at least one reflective element.

In such a case, the at least one reflective element comprises a left reflective element and a right reflective element for the user's left and right eyes, respectively. The semi-transparent reflective element is arranged to reflect the projection of the rendered image towards one of the left and right reflective elements, whilst the additional reflective element is arranged to reflect the projection of the rendered image towards another of the left and right reflective elements.

Optionally, the aforesaid configuration is implemented as a fold mirror. Optionally, in this regard, the semi-transparent reflective element and the additional reflective element are implemented as a 50/50 semi-reflective mirror and a fully-reflective mirror, respectively. Herein, the term “50/50 semi-reflective mirror” refers to a mirror that reflects 50 percent of incident light, whilst transmitting 50 percent of the incident light at least theoretically. Likewise, the term “fully-reflective mirror” refers to a mirror that reflects 100 percent of incident light at least theoretically.

Alternatively, optionally, the aforesaid configuration is implemented as a prism, wherein the semi-transparent reflective element and the additional reflective element are implemented as two surfaces of the prism.

Furthermore, optionally, a surface of the at least one optical element that faces the user's eye (when the projection apparatus in operation is worn by the user) is planar. Alternatively, optionally, said surface is curved. More optionally, said surface is concave in shape.

Optionally, the at least one optical element is implemented as at least one of: one or more lenses, one or more mirrors, a prism, a beam splitter, an optical waveguide, a polarizer.

When the at least one optical element is implemented as a configuration of lenses, said configuration may, for example, comprise at least one of: a convex lens, a planoconvex lens, a concave lens, a planoconcave lens, a Liquid Crystal (LC) lens, a liquid lens, a Fresnel lens, an achromatic lens, a meniscus lens, a nano-grating lens. Such lenses can be made from various suitable materials, for example, such as glass, plastics, polycarbonate materials, active polymers, flexible membranes and the like.

Moreover, optionally, a curvature of the at least one optical element is dynamically changeable. Optionally, in this regard, the at least one optical element is made of an active polymer or a flexible membrane. Such an active polymer or a flexible membrane is controllable by a given drive signal, for example, such as a voltage signal. Such active polymers can be amorphous, elastomeric, semi-crystalline or liquid crystalline, and can be activated in response to heat, light, and/or an electrical field. Optionally, the active polymer or the flexible membrane is actuated by the given signal to change the shape of the aforesaid surface of the at least one optical element.

Optionally, the at least one optical element comprises a semi-transparent reflective element. As an example, the semi-transparent reflective element may be implemented as a semi-transparent mirror. As another example, the semi-transparent reflective element may be implemented as a prism having a semi-transparent reflective coating on at least one face of the prism. Optionally, when the projection apparatus is switched off or or is operating in an optical see-through mode, the semi-transparent reflective element allows the user to see the surrounding real-world environment therethrough. In such a case, the projection apparatus acts as an optical see-through device.

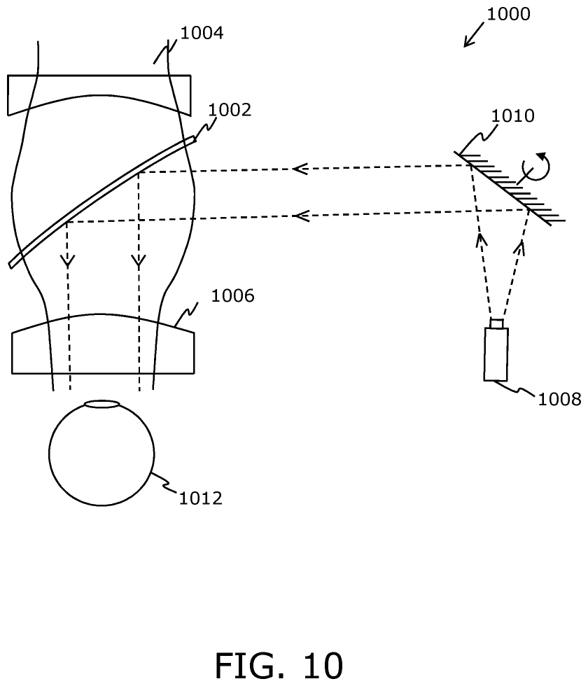

Alternatively, optionally, the at least one optical element is implemented as a telescope-like lens that focuses the projection of the rendered image onto the retina of the user's eye. It will be appreciated that such a telescope-like lens is capable of focusing a projection of the surrounding real-world environment onto the user's eye, thereby allowing the user to see the surrounding real-world environment. One example implementation of such a telescope-like lens has been illustrated in conjunction with FIG. 10, for example, as explained in detail below.

In the example implementation, the telescope-like lens comprises a semi-transparent reflective element along with at least one of: a planoconcave lens, a concave lens, a planoconvex lens, a convex lens, a meniscus lens, a Fresnel lens. The semi-transparent reflective element may be planar or curved.

In operation, the semi-transparent reflective element reflects the projection of the rendered image received from the at least one reflective element towards the user's eye.

The telescope-like lens allows the user to see her/his surrounding real-world environment, for example, when the projection apparatus is switched off or is operating in the optical see-through mode.

Yet alternatively, optionally, the at least one optical element comprises a non-transparent reflective element. In such a case, the projection apparatus operates in a video see-through mode or a full VR mode.

Still alternatively, optionally, the at least one optical element comprises an electrically-controllable polarizer. Optionally, in such a case, the at least one processor is configured to control said polarizer to toggle between the optical see-though mode and the video see-through mode.

Yet alternatively, optionally, the at least one optical element comprises a single lens. Such a single lens may be implemented as an eyepiece. One such example implementation has been illustrated in conjunction with FIG. 12. In such a case, the projection apparatus operates in the video see-through mode or the full VR mode.

Furthermore, optionally, a reflective surface of the at least one reflective element is planar. Alternatively, optionally, the reflective surface is curved. More optionally, the reflective surface is convex in shape.

For illustration purposes only, there will now be considered two example scenarios where the at least one projector has a constant resolution throughout, for example, 1000×1000 pixels. In a first example scenario, there will now be considered that the reflective surface is planar, and a field of view of the projection of the rendered image, upon being reflected by the planar reflective surface, is 50 degrees. In such a case, the angular resolution of the projection of the rendered image would be 20 pixels per degree (=1000/50 pixels per degree).

In a second example scenario, there will next be considered that the reflective surface is convex, and the field of view of the projection of the rendered image, upon being reflected by the convex reflective surface, is 35 degrees. In such a case, the angular resolution of the projection of the rendered image would be 28 pixels per degree (=1000/35 pixels per degree).

Thus, such a convex reflective surface is suitable for enhancing the angular resolution of the projection of the rendered image.

Optionally, the at least one reflective element is implemented as at least one of: a mirror, a reflective liquid lens, a reflective LC lens, a reflective membrane.

Optionally, the at least one reflective element is implemented as a Micro-Electro-Mechanical Systems (MEMS) mirror. Such a MEMS mirror is easy to adjust, owing to its light weight.

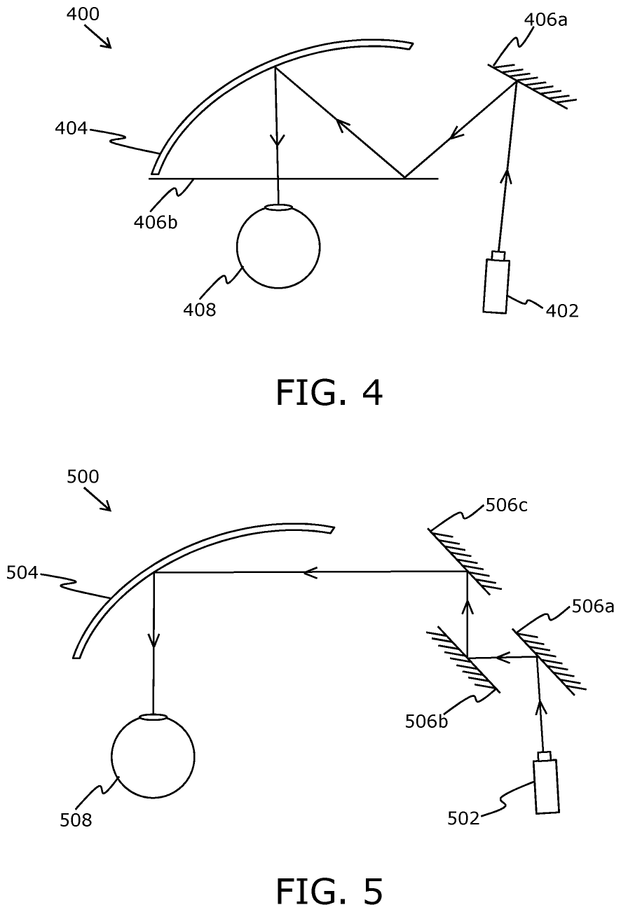

In some implementations, the at least one reflective element comprises a single reflective element. In other implementations, the at least one reflective element comprises a plurality of reflective elements that are arranged on the optical path between the at least one projector and the at least one optical element, wherein the light beam is directed towards the given portion of the at least one optical element via the plurality of reflective elements. Some examples of how such reflective elements can be arranged have been provided in conjunction with FIGS. 4 and 5.

Moreover, according to a first embodiment, the image comprises a focus image, wherein the projection apparatus further comprises at least one image renderer that is to be employed to render a context image. Optionally, in this regard, the at least one processor or an imaging unit communicably coupled to the at least one processor is configured to:

determine a region of interest of an input image based upon the detected gaze direction of the user; and

process the input image to generate the focus image and the context image, wherein the focus image corresponds to the region of interest of the input image or a part of the region of interest, while the context image corresponds to at least a region of the input image that includes and surrounds the region of interest of the input image, wherein the context image is to have a first resolution, while the focus image is to have a second resolution, the second resolution being higher than the first resolution.

In such a case, the at least one processor is configured to control the at least one projector and the at least one image renderer to render the focus image and the context image substantially simultaneously. By rendering the focus image and the context image “substantially simultaneously”, it is meant that a time instant of rendering the focus image and a time instant of rendering the context image lie within 200 milliseconds of each other, and more optionally, within 20 milliseconds of each other.

When incident upon the at least one optical element, a projection of the rendered focus image is optically combined with a projection of the context image to create the aforesaid visual scene. In other words, the projections of the focus image and the context image are superimposed to present the visual scene to the user.

Throughout the present disclosure, the term “region of interest” refers to a region of the input image at which the user's gaze is focused. In order to achieve active foveation, the region of interest is to be presented at a resolution that is much greater than resolutions of other regions of the input image.

It will be appreciated that the at least one image renderer, which is employed to render the context image, is positioned outside of a field of view of the user's eye. Such a positioning of the at least one image renderer ensures that the at least one image renderer does not block the user's view of the rendered image. Moreover, such positioning of the at least one image renderer reduces an overall size and weight of the projection apparatus, thereby making it much more comfortable for the user to wear the projection apparatus.

Optionally, the at least one image renderer is implemented as a display. Example of such a display include, but are not limited to: a Liquid Crystal Display (LCD), a Light-Emitting Diode (LED)-based display, an Organic LED (OLED)-based display, a micro OLED-based display, a Liquid Crystal on Silicon (LCoS)-based display, and a Cathode Ray Tube (CRT)-based display.

In some implementations, the input image is a computer-generated image. Optionally, in this regard, the projection apparatus comprises a memory unit coupled to the at least one processor, wherein the memory unit is employed to store a sequence of input images. Such a sequence of input images is stored in an image format that is compatible with the at least one projector and the at least one image renderer. Examples of the image format include, but are not limited to, Joint Photographic Experts Group (JPEG), Tagged Image File Format (TIFF), Portable Network Graphics (PNG), Graphics Interchange Format (GIF) and Bitmap file format (BMP).

In other implementations, the input image is representative of a real-world environment. Such a real-world environment may be a real-world environment in which the user is present physically or a real-world environment remote to the user.

Optionally, in a case where the input image is representative of the real-world environment in which the user is present physically, the projection apparatus comprises at least one first camera coupled to the at least one processor, wherein the at least one first camera is to be employed to capture an image of the real-world environment as the input image. This input image is then processed to generate the focus image and the context image.

Optionally, in such a case, the at least one first camera is mounted on the projection apparatus. The at least one first camera is positioned in a proximity of the user's eyes, so as to enable capturing of the input images from a perspective of the user's eyes. Thus, when the projection apparatus is worn by the user, the at least one first camera, in operation, captures images of the real-world environment surrounding the user as the input images.

Optionally, in another case where the input image is representative of the real-world environment that is remote to the user, the imaging unit is mounted on an external device that is remote to the projection apparatus. As an example, the external device may be implemented as a robot, a drone, a vehicle or similar.

Optionally, in such a case, the imaging unit comprises at least one second camera and a processor coupled to the at least one second camera. In such a case, the imaging unit is communicably coupled to the projection apparatus (namely, to the at least one processor of the projection apparatus) via a wired or wireless connection.

Hereinabove, the term “focus image” refers to an image that is rendered via the at least one projector of the projection apparatus, whereas the term “context image” refers to an image that is rendered via the at least one image renderer of the projection apparatus. Optionally, the focus image is generated by cropping the input image, while the context image is generated by reducing a resolution of the input image.

Optionally, the focus image is rectangular in shape. Alternatively, optionally, the focus image is circular in shape. Yet alternatively, optionally, the focus image is oval in shape. It will be appreciated that the focus image may have any other polygonal shape.

Optionally, the context image is rectangular in shape. Alternatively, optionally, the context image is circular in shape. Yet alternatively, optionally, the context image is oval in shape. It will be appreciated that the context image may have any other polygonal shape.

Optionally, an angular resolution of the rendered focus image with respect to the user's eye lies in a range of 30 to 100 pixels per degree. For example, the angular resolution of the rendered focus image may be from 30, 40, 50, 60, 70, 80, 90 pixels per degree up to 40, 50, 60, 70, 80, 90, 100 pixels per degree.

Optionally, an angular resolution of the rendered context image with respect to the user's eye lies in a range of 5 to 30 pixels per degree. For example, the angular resolution of the rendered context image may be from 5, 10, 15, 20, 25 pixels per degree up to 10, 15, 20, 25 and 30 pixels per degree.

Throughout the present disclosure, the term “angular resolution” of a given image or its region refers to a number of pixels per degree (namely, points per degree (PPD)) of an angular width of the given image or its region, wherein the angular width is measured from the perspective of the user's eye. Notably, an increase in the angular resolution results in an increase in the number of pixels per degree and a decrease in an angular pixel size.

Moreover, optionally, an angular width of the projection of the focus image with respect to the user's eye lies in a range of 5 to 60 degrees. Optionally, an angular width of the projection of the context image with respect to the user's eye lies in a range of 40 to 220 degrees. For example, the angular width of the focus image may be from 5, 10, 15, 20, 25, 30, 35, 40, 45, 50 or 55 degrees up to 10, 15, 20, 25, 30, 35, 40, 45, 50, 55 or 60 degrees. Likewise, the angular width of the context image may be from 40, 50, 60, 70, 80, 90, 100, 110, 120, 130, 140, 150, 160, 170, 180, 190, 200 or 210 degrees up to 50, 60, 70, 80, 90, 100, 110, 120, 130, 140, 150, 160, 170, 180, 190, 200, 210 or 220 degrees.

Throughout the present disclosure, the term “angular width” refers to an angular width of a given region of a given image from the perspective of the user's eye, namely with respect to a center of the user's gaze.

It will be appreciated that the angular width of the projection of the rendered context image is greater than the angular width of the projection of the rendered focus image, as the rendered focus image is projected on and around the fovea of the user's eyes, whereas the rendered context image is projected upon the retina of the user's eyes.

Furthermore, optionally, when generating the focus image and the context image, the at least one processor or the imaging unit is configured to perform at least one image-processing operation on the focus image and/or the context image, to accommodate for optical distortions (for example, such as geometric distortion, chromatic distortion and the like). The at least one image-processing operation may, for example, include at least one of: low pass filtering, image cropping, image sharpening, color processing, gamma correction, edge processing.

More optionally, the at least one processor or the imaging unit is configured to perform at least one edge-processing operation to smoothen a transition between of the focus image and the context image when they are superimposed to create the visual scene. This potentially reduces (for example, minimizes) a perceived distortion at the transition between the focus image and the context image, when the projections of the focus image and the context image are incident upon the retina of the user's eye. The at least one edge-processing operation may, for example, include a filtering operation, a pixel-intermixing operation and the like. It will be 0appreciated that the at least one edge-processing operation applies a smooth blending effect along and across the transition between the focus image and the context image. As a result, a change in the resolution (namely, from the second resolution of the focus image to the first resolution of the context image) appears as a gradual gradation to the user.

Moreover, optionally, the at least one processor or the imaging unit is configured to mask a region of the context image that corresponds to the region of interest or a part of the region of interest. Optionally, in this regard, pixels of said region of the context image are dimmed or darkened. This potentially reduces (for example, minimizes) the distortion at the transition between the focus image and the context image.

Optionally, said masking is performed using:

a linear-transparency-mask blend of inverse values between the context image and the focus image at their transition,

stealth (or camouflage) patterns containing shapes naturally difficult for detection by a human eye, and so forth.

Furthermore, optionally, the at least one optical element and the at least one image renderer are implemented together as at least one display having semi-transparent spacing between its pixels. One such example implementation has been illustrated in conjunction with FIG. 12, for example, as elucidated in detail below. Optionally, in such an implementation, the at least one display is employed to render the context image, whilst the at least one projector is employed to render the focus image.

The semi-transparent spacing between the pixels of the at least one display allows the projection of the rendered focus image to pass therethrough towards the fovea of the user's eye. In such a case, the projection apparatus operates in the video see-through mode or the full VR mode.

Alternatively, optionally, the at least one optical element comprises an optical waveguide arranged on an optical path between the at least one image renderer and the user's eye, wherein the optical waveguide is to guide the projection of the rendered context image towards the user's eye.

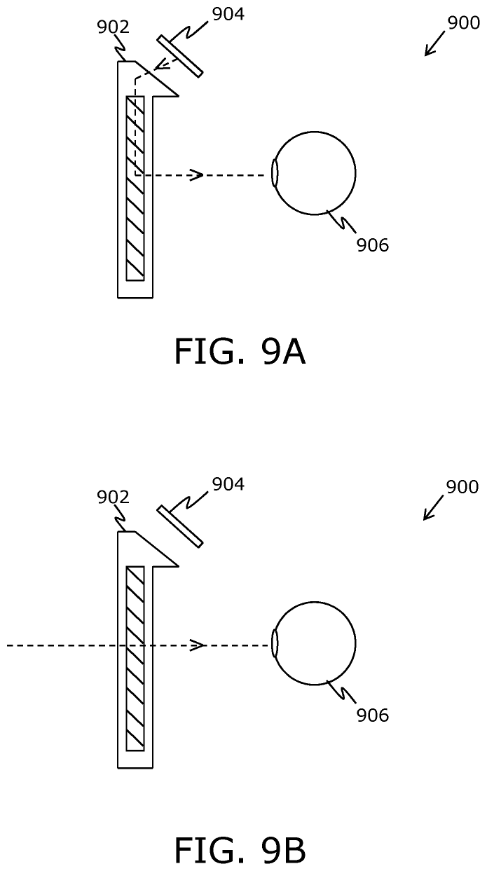

One such implementation of an optical waveguide has been illustrated in conjunction with FIGS. 9A and 9B, for example, as elucidated in detail below.

Optionally, the optical waveguide comprises a semi-transparent reflective coating on a surface or layer of the optical waveguide that faces the user's eye (when the projection apparatus in operation is worn by the user). In such a case, the semi-transparent reflective coating allows the projection of the context image to pass therethrough towards the retina of the user's eye, whilst reflecting the projection of the focus image towards the fovea of the user's eye.

Optionally, the optical waveguide further comprises optical elements, for example, such as microprisms, mirrors, diffractive optics and so forth.

Optionally, a transparency of the optical waveguide is electrically controllable. As an example, the optical waveguide may become transparent when the projection apparatus is switched off or is operating in the optical see-through mode, thereby allowing the user to see-through the real-world environment in which she/he is present.

According to a second embodiment, the image comprises the focus image, and no additional image (for example, such as the context image) is to be rendered together with the focus image. Optionally, in such a case, an angular resolution of the rendered image with respect to the user's eye lies in a range of 30 to 100 pixels per degree. For example, the angular resolution of the rendered image may be from 30, 40, 50, 60, 70, 80, 90 pixels per degree up to 40, 50, 60, 70, 80, 90, 100 pixels per degree.

It will be appreciated that the focus image is optionally generated in a manner as explained above with respect to the first embodiment.

According to a third embodiment, the image comprises a context region and a focus region, wherein the at least a portion of the rendered image comprises the focus region of the rendered image. Optionally, in this regard, the at least one processor or an imaging unit communicably coupled to the at least one processor is configured to:

determine a region of interest of the image based upon the detected gaze direction of the user;

generate pixel data for the context region and the focus region of the image, wherein the focus region corresponds to the region of interest of the image or a part of the region of interest, while the context region corresponds to a remaining region of the image or a part of the remaining region, wherein the context region is to have a first resolution, while the focus region is to have a second resolution, the second resolution being higher than the first resolution; and

control the at least one projector to render the context region and the focus region of the image using the pixel data generated therefor.

Hereinabove, the term “pixel data” refers to information pertaining to a single pixel or a set of pixels within an entire pixel array associated with a given region (namely, the context region and/or the focus region) of the image. For example, the pixel data may include information about a total number, relative sizes, colors, intensities, relative positions and an arrangement of pixels in the given region.

Optionally, the pixel data is generated separately for the context and focus regions of the image. Optionally, in such a case, the pixel data is stored in two separate frame buffers, wherein one frame buffer is employed to store the pixel data corresponding to the context region, while another frame buffer is employed to store the pixel data corresponding to the focus region.

Alternatively, optionally, the pixel data is generated collectively for the context and focus regions of the image. Optionally, in such a case, the pixel data is stored in a single frame buffer. More optionally, in such a case, the two separate frame buffers are combined into the single frame buffer.

Hereinabove, the term “frame buffer” refers to a portion of a memory that is used to store the pixel data. In order to draw the context and focus regions of the image over the at least one reflective element, the aforementioned light source of the at least one projector is driven based upon the pixel data.

Moreover, optionally, an angular width of a projection of the rendered focus region with respect to the user's eye lies in a range of 5 to 60 degrees. Optionally, an angular width of a projection of the rendered context region with respect to the user's eye lies in a range of 40 to 220 degrees. For example, the angular width of the rendered focus region may be from 5, 10, 15, 20, 25, 30, 35, 40, 45, 50 or 55 degrees up to 10, 15, 20, 25, 30, 35, 40, 45, 50, 55 or 60 degrees. Likewise, the angular width of the rendered context region may be from 40, 50, 60, 70, 80, 90, 100, 110, 120, 130, 140, 150, 160, 170, 180, 190, 200 or 210 degrees up to 50, 60, 70, 80, 90, 100, 110, 120, 130, 140, 150, 160, 170, 180, 190, 200, 210 or 220 degrees.

Optionally, when generating the pixel data for the context and focus regions of the image, the at least one processor or the imaging unit is configured to perform at least one edge-processing operation to smoothen a transition across boundaries of the context region and the focus region.

Optionally, the at least one processor or the imaging unit is configured to generate pixel data corresponding to at least one intermediate region of the input image, namely between the focus and context regions. In such a case, an angular resolution of the at least one intermediate region is higher than the angular resolution of the context region, but is lower than the angular resolution of the focus region.

Beneficially, the focus and context regions of the input image are drawn substantially simultaneously. This potentially reduces (for example, minimizes) a time lag in an optical combination of the projections of the focus and context regions, thereby providing the user with a seamless viewing experience of the visual scene.

In some implementations, the at least one projector comprises at least a first projector and a second projector per eye. In such a case, the first projector and the second projector are to be employed to render the focus region and the context region, respectively.

In other implementations, the at least one projector comprises a single projector per eye. In such a case, the single projector is to be employed to render both the focus region and the context region.

Furthermore, optionally, a first scanning pattern to be swept by the at least one controllable scanning mirror (of the at least one projector) for drawing the focus region is different from a second scanning pattern to be swept by the at least one controllable scanning mirror for drawing the context region.

Optionally, in such a case, the second scanning pattern is to have at least one additional ripple function in a direction that is substantially perpendicular to a current scanning direction. Herein, the term “ripple function” refers to a signal (for example, such as a periodic signal) superimposed upon the second scanning pattern. It will be appreciated that the at least one additional ripple function beneficially increases the angular resolution of the focus region as compared to the angular resolution of the context region.

The at least one processor is coupled to the means for detecting the gaze direction, the at least one projector and the at least one first actuator. The at least one processor is configured to control various operations of said means, the at least one projector and the at least one first actuator, as described earlier.

Moreover, optionally, the projection apparatus further comprises a light-sensing element for sensing the intensity of the light beam and means for stopping the light beam from reaching the user's eye. Optionally, in this regard, the at least one processor is configured to obtain information indicative of the intensity of the light beam, and to detect when the intensity of the light beam exceeds a predefined threshold value. Optionally, the at least one processor is configured to use said means to stop the light beam when the intensity of the light beam exceeds the predefined threshold value. The predefined threshold value may be a default value that is preset in the projection apparatus. Such predefined threshold values are based upon commonly known and practiced eye-safety guidelines.

Additionally or alternatively, optionally, the projection apparatus comprises an accelerometer that is employed to sense a pattern in which the at least one controllable scanning mirror vibrates; and means for stopping the light beam from reaching the user's eye. Optionally, in this regard, the at least one processor is configured to detect when the sensed pattern is different from a predefined pattern, and to use said means to stop the light beam when the sensed pattern is different from the predefined pattern. As an example, the predefined pattern could be a cyclic pattern of deflections of the at least one controllable scanning mirror at a predefined rate.

Optionally, the means for stopping the light beam is implemented as at least one of: an opaque shutter, an interlock mechanism associated with the light source, a glass filter, a polycarbonate filter.

The present disclosure also relates to the method as described above. Various embodiments and variants disclosed above apply mutatis mutandis to the method.

According to a first embodiment, the image comprises a focus image, and the projection apparatus further comprises at least one image renderer. In such a case, the method further comprises:

determining a region of interest of an input image based upon the detected gaze direction of the user;

processing the input image to generate the focus image and a context image, wherein the focus image corresponds to the region of interest of the input image or a part of the region of interest, while the context image corresponds to at least a region of the input image that includes or surrounds the region of interest of the input image, wherein the context image has a first resolution, while the focus image has a second resolution, the second resolution being higher than the first resolution; and

rendering the context image, via the at least one image renderer, substantially simultaneously with the rendering of the focus image.

According to a second embodiment, the image comprises the focus image, and no additional image (for example, such as the context image) is rendered together with the focus image. Optionally, in such a case, an angular resolution of the rendered image with respect to the user's eye lies in a range of 30 to 100 pixels per degree.

Optionally, the at least one optical element comprises an optical waveguide arranged on an optical path between the at least one image renderer and the user's eye, wherein the optical waveguide guides a projection of the rendered context image towards the user's eye.

According to a third embodiment, the image comprises a context region and a focus region, wherein the at least a portion of the rendered image comprises the focus region of the rendered image. In such a case, the method further comprises:

determining a region of interest of the image based upon the detected gaze direction of the user;

generating pixel data for the context region and the focus region of the image, wherein the focus region corresponds to the region of interest of the image or a part of the region of interest, while the context region corresponds to a remaining region of the image or a part of the remaining region, wherein the context region has a first resolution, while the focus region has a second resolution, the second resolution being higher than the first resolution; and

controlling the at least one projector to render the context region and the focus region of the image using the pixel data generated therefor.

Moreover, optionally, the at least one optical element comprises a semi-transparent reflective element that allows the user to see a surrounding real-world environment therethrough.

Alternatively, optionally, the at least one optical element is implemented as a telescope-like lens that focuses the projection of the rendered image onto the retina of the user's eye.

Furthermore, optionally, the method further comprises adjusting an orientation of the at least one projector with respect to the at least one reflective element to adjust a location of the projection of the at least a portion of the rendered image on the at least one optical element according to the detected gaze direction of the user.

More optionally, in the method, the at least one projector is tilted along at least one axis, whilst the at least one reflective element is tilted along at least one orthogonal axis.

### Detailed Description of the Drawings

Referring to FIG. 1, illustrated is a block diagram of architecture of a direct retina projection apparatus 100, in accordance with an embodiment of the present disclosure. The projection apparatus 100 comprises means 102 for detecting a gaze direction of a user, at least one projector (depicted as a projector 104), at least one optical element (depicted as an optical element 106), at least one reflective element (depicted as a reflective element 108), at least one first actuator (depicted as a first actuator 110), and at least one processor (depicted as a processor 112).

FIG. 1 is merely an example, which should not unduly limit the scope of the claims herein. It will be appreciated that the specific designation for the projection apparatus 100 is provided as an example and is not to be construed as limiting the projection apparatus 100 to specific numbers or types of means for detecting the gaze direction, projectors, optical elements, reflective elements, actuators, and processors. A person skilled in the art will recognize many variations, alternatives, and modifications of embodiments of the present disclosure.

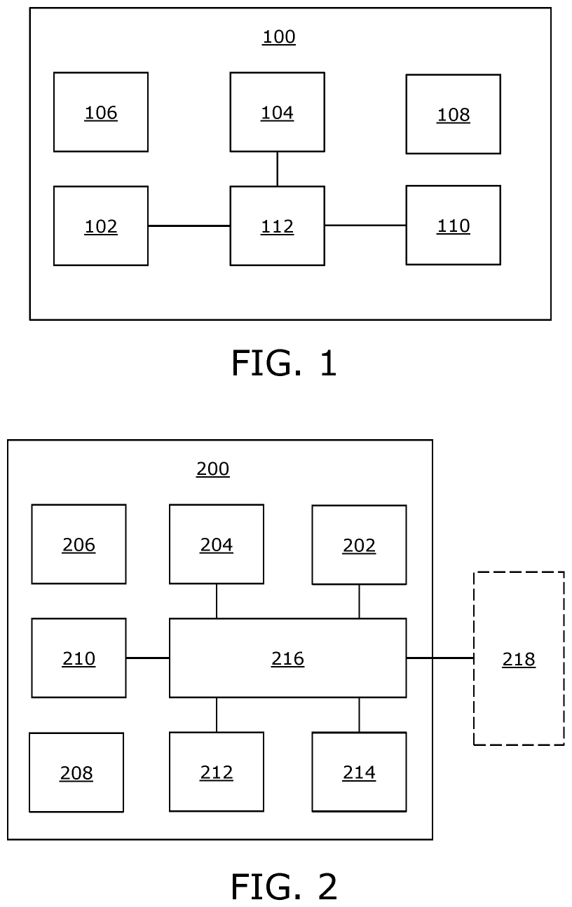

Referring to FIG. 2, illustrated is a block diagram of architecture of a direct retina projection apparatus 200, in accordance with a specific embodiment of the present disclosure. The projection apparatus 200 comprises means 202 for detecting a gaze direction of a user, at least one projector (depicted as a projector 204), at least one optical element (depicted as an optical element 206), at least one reflective element (depicted as a reflective element 208), at least one first actuator (depicted as a first actuator 210), at least one second actuator (depicted as a second actuator 212), at least one image renderer (depicted as an image renderer 214), and at least one processor (depicted as a processor 216).

Optionally, an imaging unit 218 is coupled in communication with the processor 216.

FIG. 2 is merely an example, which should not unduly limit the scope of the claims herein. It will be appreciated that the specific designation for the projection apparatus 200 is provided as an example and is not to be construed as limiting the projection apparatus 200 to specific numbers or types of means for detecting the gaze direction, projectors, optical elements, reflective elements, actuators, image renderers and processors. A person skilled in the art will recognize many variations, alternatives, and modifications of embodiments of the present disclosure.

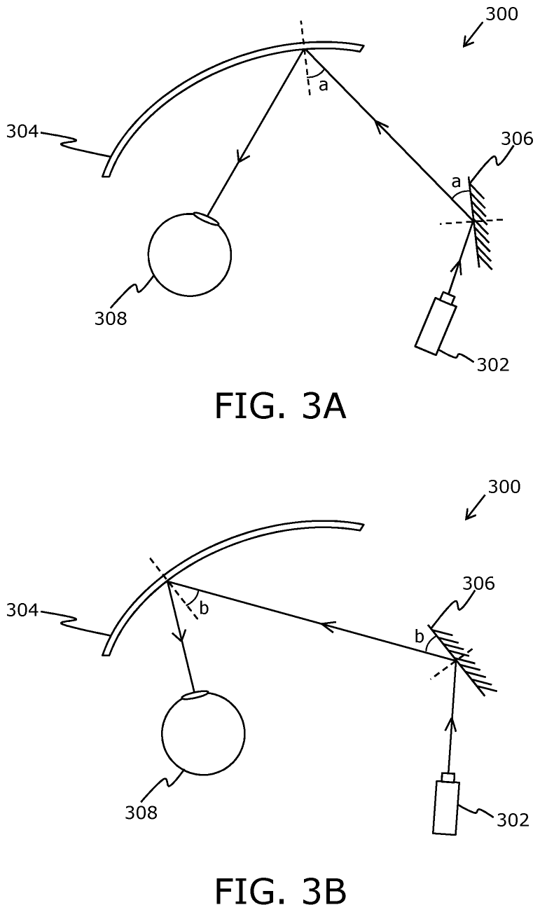

FIGS. 3A and 3B are schematic illustrations of how active foveation is achieved in a direct retina projection apparatus 300, in accordance with an embodiment of the present disclosure. There are shown a projector 302, an optical element 304 and a reflective element 306 of the projection apparatus 300, and a user's eye 308.

With reference to FIG. 3A, a user's gaze direction is detected at a first instant of time. A first portion of the optical element 304 at or through which the user is gazing is determined based upon the detected gaze direction. A first image is then rendered via the projector 302, whilst an orientation of the reflective element 306 is adjusted to reflect a projection of the rendered first image (from the reflective element 306) towards the first portion of the optical element 304. As a result, a projection of at least a portion of the rendered first image is directed from the first portion of the optical element 304 towards a fovea of the user's eye 308.

With reference to FIG. 3B, the user's gaze direction is detected at a second instant of time, and a second portion of the optical element 304 at or through which the user is gazing is determined accordingly. A second image is then rendered via the projector 302, whilst the orientation of the reflective element 306 is adjusted to reflect a projection of the rendered second image (from the reflective element 306) towards the second portion of the optical element 304. As a result, a projection of at least a portion of the rendered second image is directed from the second portion of the optical element 304 towards the fovea of the user's eye 308.

In this way, active foveation is achieved even when the user's gaze shifts from time to time.

According to laws of reflection, an angle between a reflected ray and a tangent at a surface of the reflective element 306 is equal to an angle between an incident ray and a normal at a surface of the optical element 304, as shown in FIGS. 3A and 3B.

FIGS. 3A and 3B collectively are merely an example, which should not unduly limit the scope of the claims herein. A person skilled in the art will recognize many variations, alternatives, and modifications of embodiments of the present disclosure. It will be appreciated that the terms “first” and “second” used herein do not denote any order, quantity or importance, but rather are used to distinguish one element from another.

FIG. 4 is a schematic illustration of an exemplary implementation of a direct retina projection apparatus 400, in accordance with an embodiment of the present disclosure. The projection apparatus 400 comprises means for detecting a gaze direction of a user (not shown), at least one projector (depicted as a projector 402), at least one optical element (depicted as an optical element 404), at least one reflective element (depicted as reflective elements 406a and 406b), at least one first actuator (not shown), and at least one processor (not shown).

In FIG. 4, there is shown how a projection of an image rendered via the projector 402 is reflected and directed towards a fovea of a user's eye 408 via the reflective elements 406a and 406b and the optical element 404.

FIG. 4 is merely an example, which should not unduly limit the scope of the claims herein. A person skilled in the art will recognize many variations, alternatives, and modifications of embodiments of the present disclosure. In an alternative embodiment, the at least one optical element is implemented as a prism, and the reflective element 406b is implemented as a semi-transparent reflective surface of the prism.

FIG. 5 is a schematic illustration of another exemplary implementation of a direct retina projection apparatus 500, in accordance with another embodiment of the present disclosure. The projection apparatus 500 comprises means for detecting a gaze direction of a user (not shown), at least one projector (depicted as a projector 502), at least one optical element (depicted as an optical element 504), at least one reflective element (depicted as reflective elements 506a, 506b and 506c), at least one first actuator (not shown), and at least one processor (not shown).

In FIG. 5, there is shown how a projection of an image rendered via the projector 502 is reflected and directed towards a fovea of a user's eye 508 via the reflective elements 506a, 506b and 506c and the optical element 504.

FIG. 5 is merely an example, which should not unduly limit the scope of the claims herein. A person skilled in the art will recognize many variations, alternatives, and modifications of embodiments of the present disclosure.

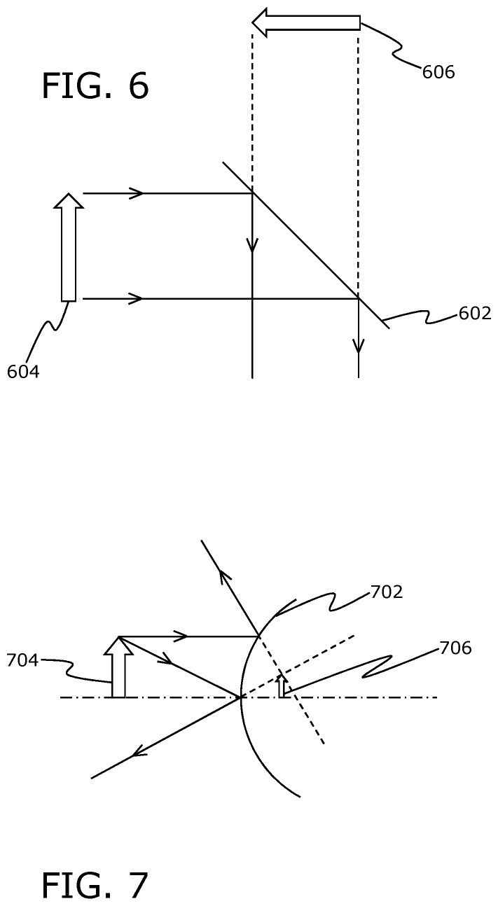

Next, FIG. 6 is a schematic illustration of how an image is formed when a planar reflective element 602 is employed, in accordance with an embodiment of the present disclosure. Upon being reflected from the planar reflective element 602, a projection of an image 604 is neither magnified nor de-magnified to produce an inverted image 606 that has an angular width that is equal to an angular width of the image 604.

FIG. 7 is a schematic illustration of how an image is formed when a convex reflective element 702 is employed, in accordance with another embodiment of the present disclosure. Upon being reflected from the convex reflective element 702, a projection of an image 704 is de-magnified to produce an inverted image 706 that has an angular width that is smaller than an angular width of the image 704. As a result, an apparent angular resolution of the image 706 increases.

FIGS. 6 and 7 are merely examples, which should not unduly limit the scope of the claims herein. A person skilled in the art will recognize many variations, alternatives, and modifications of embodiments of the present disclosure.

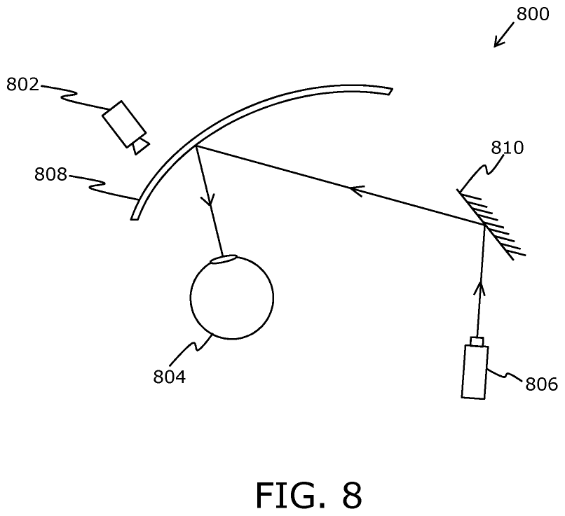

Referring next to FIG. 8, illustrated is an exemplary implementation of means for detecting a gaze direction of a user in a direct retina projection apparatus 800, in accordance with an embodiment of the present disclosure. The means for detecting the gaze direction comprises at least one camera per eye, depicted as a camera 802. The camera 802 is arranged to capture an image of a user's eye 804.

The projection apparatus 800 comprises said means, at least one projector (depicted as a projector 806), at least one optical element (depicted as an optical element 808), at least one reflective element (depicted as a reflective element 810), at least one first actuator (not shown), and at least one processor (not shown).

A projection of an image rendered via the projector 806 is reflected and directed towards a fovea of the user's eye 804 via the reflective element 810 and the optical element 808. Meanwhile, the image of the user's eye 804 as captured by the camera 802 is analyzed to determine a current gaze direction of the user.

FIG. 8 is merely an example, which should not unduly limit the scope of the claims herein. A person skilled in the art will recognize many variations, alternatives, and modifications of embodiments of the present disclosure.

Referring next to FIGS. 9A and 9B, illustrated is an exemplary implementation of at least one optical element in a direct retina projection apparatus 900, in accordance with an embodiment of the present disclosure. The at least one optical element is implemented as an optical waveguide 902.

The projection apparatus 900 comprises at least one projector (not shown) and at least one image renderer (depicted as an image renderer 904). A focus image is rendered via the at least one projector, while a context image is rendered via the image renderer 904.

In operation, the optical waveguide 902 receives a projection of the rendered context image from the image renderer 904, and guides the projection of the rendered context image towards a user's eye 906, as shown in FIG. 9A.

With reference to FIG. 9B, the optical waveguide 902 is semi-transparent. The optical waveguide 902 allows the user to see her/his surrounding real-world environment, for example, when the projection apparatus 900 is switched off or is operating in an optical see-through mode.

Referring to FIG. 10, illustrated is another exemplary implementation of at least one optical element in a direct retina projection apparatus 1000, in accordance with another embodiment of the present disclosure. The at least one optical element is implemented as a telescope-like lens that comprises a semi-transparent reflective element 1002 along with at least one of: a planoconcave lens, a concave lens, a planoconvex lens, a convex lens, a meniscus lens, a Fresnel lens.

It will be appreciated that the telescope-like lens is not limited to any particular type, number or arrangement of such lenses. In FIG. 10, there are shown a planoconcave lens 1004 and a planoconvex lens 1006 for illustration purposes only.

The projection apparatus 1000 comprises at least one projector (depicted as a projector 1008) and at least one reflective element (depicted as a reflective element 1010).

The semi-transparent reflective element 1002 may be planar or curved.

In operation, an image is rendered via the projector 1008, and the semi-transparent reflective element 1002 receives a projection of the rendered image from the reflective element 1010, and reflects the projection of the rendered image towards a fovea of a user's eye 1012, as shown in FIG. 10.

The telescope-like lens allows the user to see her/his surrounding real-world environment, for example, when the projection apparatus 1000 is switched off or is operating in an optical see-through mode.

FIGS. 9A and 9B and FIG. 10 are merely examples, which should not unduly limit the scope of the claims herein. A person skilled in the art will recognize many variations, alternatives, and modifications of embodiments of the present disclosure. As an example, multiple lenses can alternatively be employed instead of the planoconcave lens 1004; likewise, multiple lenses can alternatively be employed instead of the planoconvex lens 1006. As another example, one of the planoconcave lens 1004 and the planoconvex lens 1006 can be absent.

Next, in FIG. 11, illustrated is an example implementation of a direct retina projection apparatus 1100 in which a single projector 1102 is employed on a shared basis, according to an embodiment of the present disclosure. Apart from the projector 1102, the projection apparatus 1100 comprises optical elements 1104a and 1104b, reflective elements 1106a, 1106b, 1106c and 1106d, and a configuration of a semi-transparent reflective element 1108 and an additional reflective element 1110.

The semi-transparent reflective element 1108 is arranged to partially reflect a projection of an image rendered by the projector 1102 towards the reflective element 1106b, which reflects said projection towards the reflective element 1106a, which then reflects said projection towards the optical element 1104a, from where said projection is reflected and directed towards a fovea of a user's eye 1112a. As shown in FIG. 11, the semi-transparent reflective element 1108 partially transmits the projection of the rendered image towards the additional reflective element 1110.

The additional reflective element 1110 is arranged to reflect the projection of the rendered image towards the reflective element 1106c, which reflects said projection towards the reflective element 1106d, which then reflects said projection towards the optical element 1104b, from where said projection is reflected and directed towards a fovea of a user's eye 1112b.

Beneficially, the projector 1102, the semi-transparent reflective element 1108, the additional reflective element 1110 and the reflective elements 1106a, 1106b, 1106c and 1106d are arranged outside of a field of view of the user's eyes 1112a and 1112b. Instead of being arranged in front of the user's eyes 1112a and 1112b (as would appear due to a two-dimensional nature of FIG. 11), these components of the projection apparatus 1100 may be arranged above and around the user's eyes 1112a and 1112b when the projection apparatus 1100 is worn by the user. It will thus be appreciated that rays depicted in FIG. 11 may not necessarily be on a same plane.

In FIG. 12, illustrated is another example implementation of a direct retina projection apparatus 1200 in which a single projector 1202 is employed on a shared basis, according to another embodiment of the present disclosure. Apart from the projector 1202, the projection apparatus 1200 comprises optical elements 1204a and 1204b, reflective elements 1206a and 1206b, and a configuration of a semi-transparent reflective element 1208 and an additional reflective element 1210.

The semi-transparent reflective element 1208 is arranged to partially reflect a projection of an image rendered by the projector 1202 towards the reflective element 1206a, which reflects said projection towards the optical element 1204a, from where said projection is directed towards a fovea of a user's eye 1212a. As shown in FIG. 12, the semi-transparent reflective element 1208 partially transmits the projection of the rendered image towards the additional reflective element 1210.

The additional reflective element 1210 is arranged to reflect the projection of the rendered image towards the reflective element 1206b, which reflects said projection towards the optical element 1204b, from where said projection is directed towards a fovea of a user's eye 1212b.

It will thus be appreciated that rays depicted in FIG. 12 may not necessarily be on a same plane.

FIGS. 11 and 12 are merely examples, which should not unduly limit the scope of the claims herein. A person skilled in the art will recognize many variations, alternatives, and modifications of embodiments of the present disclosure.

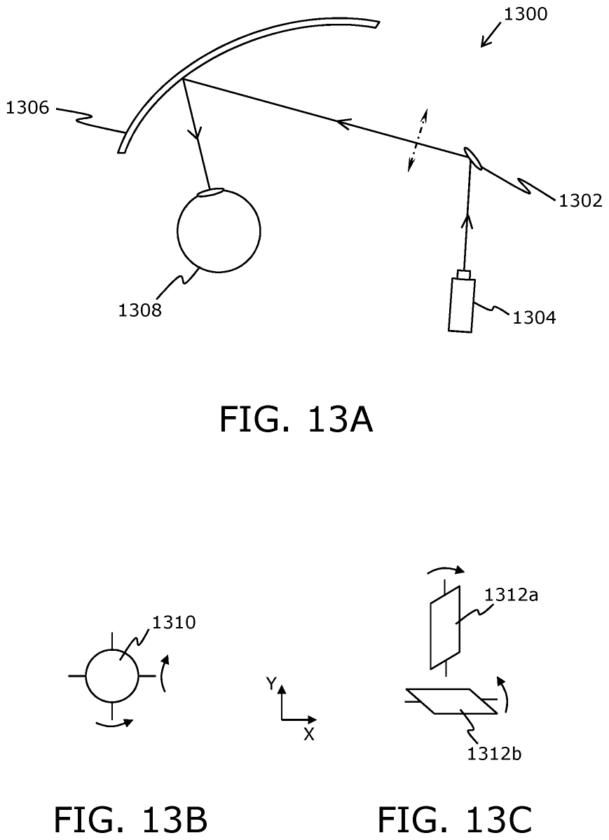

Referring next to FIGS. 13A, 13B and 13C, illustrated are exemplary implementations of at least one first actuator associated with at least one reflective element in a direct retina projection apparatus 1300, in accordance with various embodiments of the present disclosure.

With reference to FIG. 13A, the at least one reflective element and the at least one first actuator are implemented as a MEMS mirror 1302. Apart from the MEMS mirror 1302, the projection apparatus 1300 comprises means for detecting a gaze direction of a user (not shown), at least one projector (depicted as a projector 1304), at least one optical element (depicted as an optical element 1306), and at least one processor (not shown).

The at least one processor is configured to control the MEMS mirror 1302 according to the detected gaze direction of the user, whilst rendering an image via the projector 1304. As a result, a projection of the rendered image is directed towards a fovea of the user's eye 1308.

With reference to FIG. 13B, the at least one first actuator is implemented as a two-axis actuator 1310.

With reference to FIG. 13C, the at least one first actuator is implemented as two separate one-axis actuators 1312a and 1132b.

FIGS. 13A, 13B and 13C are merely examples, which should not unduly limit the scope of the claims herein. A person skilled in the art will recognize many variations, alternatives, and modifications of embodiments of the present disclosure.

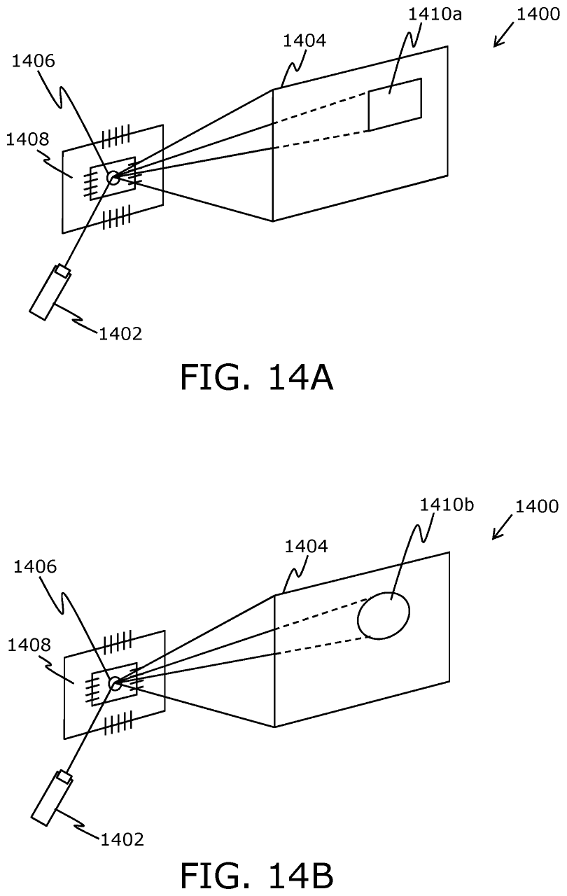

Next, FIGS. 14A and 14B are schematic illustrations of how an image is rendered in a direct retina projection apparatus 1400, in accordance with different embodiments of the present disclosure. The projection apparatus 1400 comprises means for detecting a gaze direction of a user (not shown), at least one projector (depicted as a projector 1402), at least one optical element (depicted as an optical element 1404), at least one reflective element (depicted as a reflective element 1406), at least one first actuator (depicted as a first actuator 1408), and at least one processor (not shown).

With reference to FIG. 14A, the image is rectangular in shape, and the projector 1402 is configured to draw the image using a raster scanning pattern or a Lissajous scanning pattern. As a result, a projection 1410a of the image that is incident upon the optical element 1404 appears rectangular in shape.

With reference to FIG. 14B, the image is circular in shape, and the projector 1402 is configured to draw the image using a spiral scanning pattern. As a result, a projection 1410b of the image that is incident upon the optical element 1404 appears circular in shape.

FIGS. 14A and 14B are merely examples, which should not unduly limit the scope of the claims herein. A person skilled in the art will recognize many variations, alternatives, and modifications of embodiments of the present disclosure. It will be appreciated that the image can be drawn in any suitable shape, for example, such as a square shape, a hexagonal shape or any other polygonal shape.

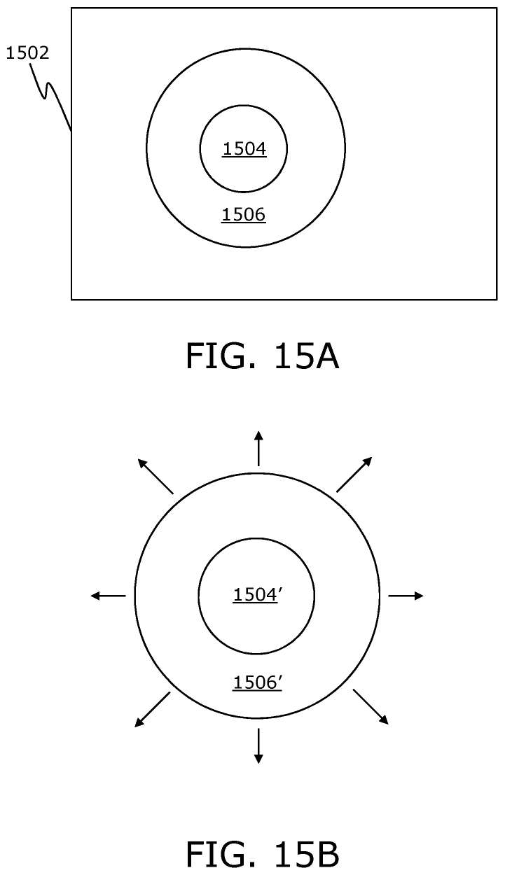

FIGS. 15A and 15B are schematic illustrations of how an input image 1502 is processed to generate an image to be rendered, in accordance with an embodiment of the present disclosure.

A region of interest 1504 of the input image 1502 is determined based upon a gaze direction of a user.

Optionally, the image to be rendered comprises a focus image that corresponds to the region of interest 1504 or a part thereof. Additionally, optionally, a context image is generated corresponding to at least a region 1506 of the input image 1502 that includes and surrounds the region of interest 1504.

Alternatively, optionally, the image to be rendered corresponds to the region of interest 1504 or the region 1506.

With reference to FIG. 15B, a region of interest 1504′ of a given input image and a region 1506′ that includes and surrounds the region of interest 1504′ shifts with a shift in the user's gaze.

FIGS. 15A and 15B are merely examples, which should not unduly limit the scope of the claims herein. A person skilled in the art will recognize many variations, alternatives, and modifications of embodiments of the present disclosure.

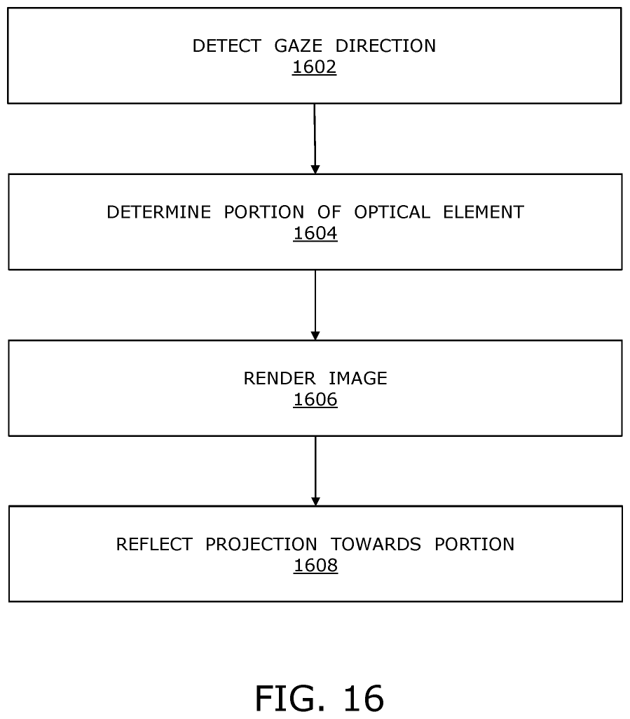

Referring to FIG. 16, illustrated are steps of a method of displaying, via a direct retina projection apparatus, in accordance with an embodiment of the present disclosure. The projection apparatus comprising at least one projector, at least one optical element and at least one reflective element arranged between the at least one projector and the at least one optical element.

At a step 1602, a gaze direction of a user is detected. At a step 1604, a given portion of the at least one optical element at or through which the user is gazing is determined based upon the detected gaze direction of the user.

Subsequently, at a step 1606, an image is rendered via the at least one projector. Meanwhile, at step 1608, an orientation of the at least one reflective element is adjusted to reflect the projection of the rendered image from the at least one reflective element towards the at least one optical element according to the detected gaze direction of the user. Consequently, a projection of at least a portion of the rendered image is reflected from the at least one reflective element towards the given portion of the at least one optical element from where the projection of the at least a portion of the rendered image is directed towards a fovea of the user's eye.

The steps 1602, 1604, 1606 and 1608 are only illustrative and other alternatives can also be provided where one or more steps are added, one or more steps are removed, or one or more steps are provided in a different sequence without departing from the scope of the claims herein. For example, the steps 1606 and 1608 can be performed in a reverse order.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A direct retina projection apparatus comprising:
means for detecting a gaze direction of a user;
at least one projector wherein the at least one projector is to be employed to render an image;
at least one optical element arranged to receive and direct a projection of the rendered image towards a retina of a user's eye when the projection apparatus in operation is worn by the user;
at least one reflective element arranged on an optical path between the at least one projector and the at least one optical element;
at least one first actuator for adjusting an orientation of the at least one reflective element; and
at least one processor configured to:
determine, based upon the detected gaze direction of the user, a given portion of the at least one optical element at or through which the user is gazing; and
control the at least one first actuator to reflect the projection of the rendered image from the at least one reflective element towards the at least one optical element according to the detected gaze direction of the user, wherein a projection of at least a portion of the rendered image is to be reflected from the at least one reflective element towards the given portion of the at least one optical element from where the projection of the at least a portion of the rendered image is directed towards a fovea of the user's eye.

2. The projection apparatus of claim 1, wherein an angular resolution of the rendered image with respect to the user's eye lies in a range of 30 to 100 pixels per degree.

3. The projection apparatus of claim 1, wherein the image comprises a focus image, the projection apparatus further comprising at least one image renderer that is to be employed to render a context image,
wherein the at least one processor or an imaging unit communicably coupled to the at least one processor is configured to:
determine a region of interest of an input image based upon the detected gaze direction of the user; and
process the input image to generate the focus image and the context image, wherein the focus image corresponds to the region of interest of the input image or a part of the region of interest, while the context image corresponds to at least a region of the input image that includes or surrounds the region of interest of the input image, wherein the context image is to have a first resolution, while the focus image is to have a second resolution, the second resolution being higher than the first resolution; and
wherein the at least one processor is configured to control the at least one projector and the at least one image renderer to render the focus image and the context image substantially simultaneously.

4. The projection apparatus of claim 3, wherein the at least one optical element comprises an optical waveguide arranged on an optical path between the at least one image renderer and the user's eye, wherein the optical waveguide is to guide a projection of the rendered context image towards the user's eye.

5. The projection apparatus of claim 1, wherein the image comprises a context region and a focus region, wherein the at least a portion of the rendered image comprises the focus region of the rendered image, and wherein the at least one processor or an imaging unit communicably coupled to the at least one processor is configured to:
determine a region of interest of the image based upon the detected gaze direction of the user;
generate pixel data for the context region and the focus region of the image, wherein the focus region corresponds to the region of interest of the image or a part of the region of interest, while the context region corresponds to a remaining region of the image or a part of the remaining region, wherein the context region is to have a first resolution, while the focus region is to have a second resolution, the second resolution being higher than the first resolution; and
control the at least one projector to render the context region and the focus region of the image using the pixel data generated therefor.

6. The projection apparatus of claim 1, wherein the at least one optical element comprises a semi-transparent reflective element that allows the user to see a surrounding real-world environment therethrough.

7. The projection apparatus of claim 1, wherein the at least one optical element is implemented as a telescope-like lens that focuses the projection of the rendered image onto the retina of the user's eye.

8. The projection apparatus of claim 1, further comprising at least one second actuator for adjusting an orientation of the at least one projector with respect to the at least one reflective element, wherein the at least one processor is configured to control the at least one second actuator along with the at least one first actuator to adjust a location of the projection of the at least a portion of the rendered image on the at least one optical element according to the detected gaze direction of the user.

9. The projection apparatus of claim 8, wherein the at least one second actuator is tiltable along at least one axis, and the at least one first actuator is tiltable along at least one orthogonal axis.

10. A method of displaying, via a direct retina projection apparatus comprising at least one projector, at least one optical element and at least one reflective element arranged between the at least one projector and the at least one optical element, the method comprising:
detecting a gaze direction of a user;
determining, based upon the detected gaze direction of the user, a given portion of the at least one optical element at or through which the user is gazing;
rendering an image via the at least one projector;
adjusting an orientation of the at least one reflective element to reflect the projection of the rendered image from the at least one reflective element towards the at least one optical element according to the detected gaze direction of the user, wherein a projection of at least a portion of the rendered image is reflected from the at least one reflective element towards the given portion of the at least one optical element from where the projection of the at least a portion of the rendered image is directed towards a fovea of the user's eye.

11. The method of claim 10, wherein an angular resolution of the rendered image with respect to the user's eye lies in a range of 30 to 100 pixels per degree.

12. The method of claim 10, wherein the image comprises a focus image, the projection apparatus further comprising at least one image renderer, wherein the method further comprises:
determining a region of interest of an input image based upon the detected gaze direction of the user;
processing the input image to generate the focus image and a context image, wherein the focus image corresponds to the region of interest of the input image or a part of the region of interest, while the context image corresponds to at least a region of the input image that includes or surrounds the region of interest of the input image, wherein the context image has a first resolution, while the focus image has a second resolution, the second resolution being higher than the first resolution; and
rendering the context image, via the at least one image renderer, substantially simultaneously with the rendering of the focus image.

13. The method of claim 12, wherein the at least one optical element comprises an optical waveguide arranged on an optical path between the at least one image renderer and the user's eye, wherein the optical waveguide guides a projection of the rendered context image towards the user's eye.

14. The method of claim 10, wherein the image comprises a context region and a focus region, wherein the at least a portion of the rendered image comprises the focus region of the rendered image, the method further comprising:
determining a region of interest of the image based upon the detected gaze direction of the user;
generating pixel data for the context region and the focus region of the image, wherein the focus region corresponds to the region of interest of the image or a part of the region of interest, while the context region corresponds to a remaining region of the image or a part of the remaining region, wherein the context region has a first resolution, while the focus region has a second resolution, the second resolution being higher than the first resolution; and
controlling the at least one projector to render the context region and the focus region of the image using the pixel data generated therefor.

15. The method of claim 1, wherein the at least one optical element comprises a semi-transparent reflective element that allows the user to see a surrounding real-world environment therethrough.

16. The method of claim 10, wherein the at least one optical element is implemented as a telescope-like lens that focuses the projection of the rendered image onto the retina of the user's eye.

17. The method of claim 10, further comprising adjusting an orientation of the at least one projector with respect to the at least one reflective element to adjust a location of the projection of the at least a portion of the rendered image on the at least one optical element according to the detected gaze direction of the user.

18. The method of claim 17, wherein the at least one projector is tilted along at least one axis, whilst the at least one reflective element is tilted along at least one orthogonal axis.
